(19) United States
(12) Patent Application Publication
(10) Pub. No.: US 2011/0295612 A1
(43) Pub. Date: Dec. 1, 2011

(54) METHOD AND APPARATUS FOR USER MODELIZATION

(76) Inventors: THIERRY DONNEAU-GOLENCER, Menlo Park, CA (US); STEPHEN L. HARDT, Woodinville, WA (US)

(21) Appl. No.: 13/149,536

(22) Filed: May 31, 2011

Related U.S. Application Data
(60) Provisional application No. 61/349,649, filed on May 28, 2010.

(51) Int. Cl. G06Q 99/00

(52) U.S. Cl. 705/1.1

(57) ABSTRACT

The present disclosure relates to methods and apparatuses for user modelization. In one embodiment, a method builds a profile that describes the interests of a user by monitoring automatically over time a plurality of interactions between the user and a computing device controlled by the user. The plurality of interactions includes interactions with a plurality of different computer applications. The method further includes extracting automatically electronic data from the plurality of interactions and determining automatically the interests in accordance with the electronic data. The method then saves the interests in the profile, such that the profile is based on behaviors specific to the user.

### CROSS REFERENCE TO RELATED APPLICATIONS

This application claims the benefit of U.S. Provisional Patent Application No. 61/349,649, filed May 28, 2010, which is herein incorporated by reference in its entirety.

### FIELD OF THE DISCLOSURE

The present disclosure relates generally to data management, and relates more particularly to technology for assisting in data management.

### BACKGROUND OF THE DISCLOSURE

The concept of personalization, as applied to computing and data network applications, uses technology to accommodate the differences between individuals and deliver more relevant content or services. However, personalization often relies on collaborative filtering techniques, such as the use of crowd sourcing, to serve relevant material based on the preferences of like-minded others. For example, crowd sourcing depends on user feedback or preferences and typically recommends items based on global popularity. Thus, there is a need for personalization based on personal relevance and which is not necessarily based on global popularity and other users' preferences.

### SUMMARY OF THE DISCLOSURE

The present disclosure relates to methods and apparatuses for user modelization (building an individual user profile). In one embodiment, a method builds a profile that describes the interests of a user by monitoring automatically over time a plurality of interactions between the user and a computing device controlled by the user. The plurality of interactions includes interactions with a plurality of different computer applications. The method further includes extracting automatically electronic data from the plurality of interactions and determining automatically the interests in accordance with the electronic data. The method then saves the interests in the profile, such that the profile is based on behaviors specific to the user.

### BRIEF DESCRIPTION OF THE DRAWINGS

The teachings of the present disclosure can be readily understood by considering the following detailed description in conjunction with the accompanying drawings, in which:

FIG. 1 is a schematic diagram illustrating one embodiment of a system including a harvester, according to the present disclosure;

FIG. 2 is a flow diagram illustrating one embodiment of a method for building a user profile, according to the present disclosure;

FIG. 3 illustrates an exemplary source document, according to the present disclosure;

FIG. 4 illustrates one embodiment of a user profile, according to the present disclosure;

FIG. 5 illustrates one embodiment of a clustering visualization, according to the present disclosure; and

FIG. 6 is a high level block diagram of the present disclosure implemented using a general purpose computing device.

To facilitate understanding, identical reference numerals have been used, where possible, to designate identical elements that are common to the figures.

### DETAILED DESCRIPTION

The present disclosure relates to user modelization. In particular, embodiments of the present disclosure leverage multiple sources to build a user model, or profile, that is individual to a specific user. For example, electronic information regarding user interactions with various applications via a computing device controlled by the user is harvested. The information may be harvested from sources such as emails, contacts, files used, bookmarks created in a document or file, webpage bookmarks made via a web browser application, web pages visited, and the like. In particular, the electronic information may comprise keywords, such as the most important words and/or semantic information in a document. In one embodiment, the most important words are determined by various algorithms such as a modified tf-idf algorithm (described below). Semantic information (such as proper nouns, people's names, place names, email addresses, phrases, telephone numbers, dates, times, addresses, and the like) mined or extracted from the user's interactions with various applications may also be taken into account in determining keywords. In other words, one or more keywords may comprise semantic information, such as a phone number, email address, proper name, a well-known phrase, and the like, rather than comprising a “regular” word. In addition, information contained in or associated with various objects, files and/or documents, such as the most frequent words in a document, the frequency of use or viewing of an object, the recency of use, folder name(s) accessed, search queries executed by the user (e.g., in a web search, desktop search, calendar or contact list search, local network search, etc.), and similar data reflect the user's interactions with various applications via a computing device, and may all be taken into account in determining a number of keywords and a respective weight for each of the keywords. The keywords extracted from a particular source, such as an email document, may be “tagged” or added to the source as metadata or otherwise associated with the source (e.g., in a database or other relational data structure implemented in a non-transitory computer readable storage medium). The keywords extracted from all or a number of sources are aggregated into a global dictionary and classified in order to create a number of topics, or themes. The individual sources are then clustered into the topics based on the keywords and their respective weights. A global dictionary, a number of topics, and associated weights are thus maintained in a user profile.

In one embodiment, new sources are continuously harvested as the user continues to use an electronic personal device and/or interact with the cloud. The user profile is updated as the new sources are harvested and the keywords (and semantic information) extracted. Specifically, the new source is added to one or more of the clusters based on the matching of the keywords extracted from the new source with the topical information (such as keywords and weights) associated with the existing topics. In one embodiment, if the keywords of a new source do not fit well into any existing topics, and the new source therefore does not relate to any existing cluster, a new topic may be created and the new source placed in a new cluster corresponding to the new topic.

In addition, existing sources may be reprocessed when the existing sources are viewed, modified, deleted, or otherwise used. Specifically, keywords are extracted from a source document, and the source metadata and the user profile are updated accordingly. Further, in one embodiment, the user profile, or model, is updated based on automatic and/or user feedback as to the accuracy of the profile's predictions. Embodiments of the present disclosure thus provide enhanced personalization of a user profile that can be used for multiple applications including, desktop assistance for assisting the user in completing a workflow on a computing device, assisting the user in a collaborative workflow including the user and another individual (such as an instant message session, an interactive virtual workspace collaboration, and the like), information discovery, rating of articles, desktop and web search, document management, team collaboration, and numerous other tasks. Accordingly, the user profile reflects both the short-term interests of the user, e.g., “hot” topics for the user at the current time, as well as the long-term interests of the user, as gleaned from the keywords of various documents associated with the user, as well as behaviors specific to the user, such as the recency of accessing various documents of interest to the user, and the like.

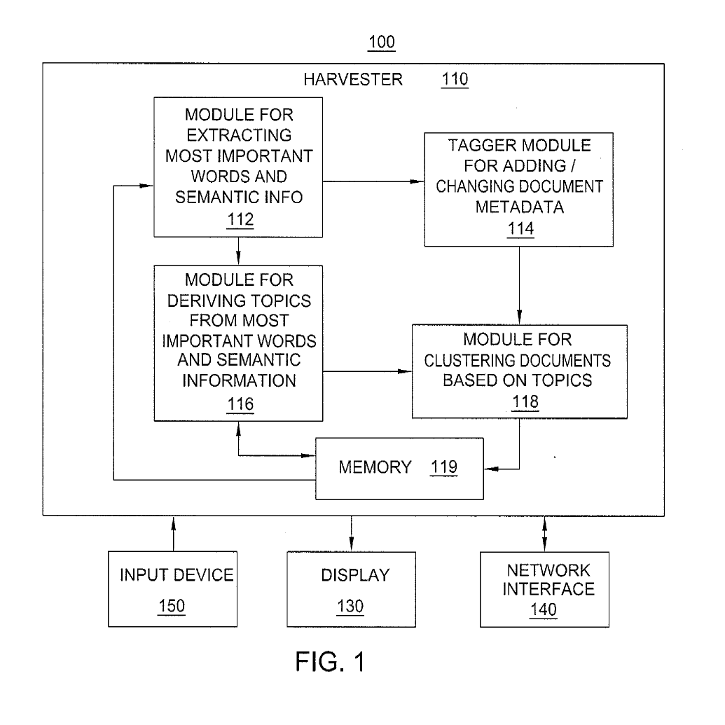

FIG. 1 is a schematic diagram illustrating one embodiment of a user profile builder system 100, according to the present disclosure. In one embodiment, the profile builder system 100 includes a “harvester” 110 that is comprised of a series of modules 112, 114, 116 and 118 and a memory 119 that are collectively configured to create and maintain a user profile, and other information related thereto. In one embodiment, each of the modules 112, 114, 116 and 118 may comprise a processor or series of processors configured to perform various tasks related to creating, modifying, and storing a user profile. Each of the processors may execute instructions stored in a memory (within the module itself or in memory 119) for performing the described functions. Although only one example of a profile builder system 100 is provided in FIG. 1, it should be understood that other, further, and different embodiments may be implemented remotely “in the cloud,” such as on a server connected to the Internet, a wide area network (WAN), a local area network (LAN), in an enterprise network, and the like. As illustrated, the main components of the user profile builder system 100 are a harvester 110, a display 130, a network interface 140, and an input device 150.

The harvester 110 indexes and processes source documents including files (e.g., word processing files, spreadsheet files, presentation files, individual slides in presentation files, etc.), webpages, calendar events, to do lists, notes, emails, and email attachments. In this context, the term “document” may include any type of electronic file that can be accessed, viewed, created, modified, and/or manipulated by a user. Thus, the term “document” may also be used to describe electronic images, videos, audio files, spreadsheets, slideshows, presentations, other multimedia, calendar and to-do list information, search queries, RSS feeds or “tweets” subscribed to, configuration files that include cookies, web histories, and various other documents which pertain to user interactions with various applications via a computing device.

For example, the user may be shopping for a new car and view various websites with classified advertisements, read various reviews, subscribe to news feeds related to car reviews, make appointments in a calendar/schedule application for test driving vehicles, email various car dealerships, and the like. These behaviors are reflected in various source documents that can be used to determine a user profile (e.g., emails, calendar entries, web cookies, web history, bookmarks, contact entries, configuration files reflecting feed subscriptions, and more). Based upon this user's actions, the user profile should reflect a strong interest in cars and even in some specific attributes of cars, such as types of cars (e.g., sedans, SUVs, hybrids, convertible, etc.), make or brand of car, and the like.

Another user may be looking for employment opportunities. This user may have many new contact list entries, emails and calendar entries reflecting the user's efforts to network in the particular field and city in which the user is attempting to gain employment. This user's profile should reflect an interest in the particular field, as well as an interest in the city/region in which the user is most interested in gaining a job.

Another user may be interested in dating or finding friends with similar hobbies and interests. This user's profile may therefore be based in large part upon the user's personal ads posted online or other postings on social media websites in which the user describes his or her interests.

In any event, these numerous sources, or source documents, may be retrieved locally, e.g., from the harvester 110 (which may also comprise the user's computer) and/or remotely from network storage (e.g., a server that stores documents produced by a plurality of users) via network interface 140. In the latter case, the harvester 110 may also retrieve or receive documents from the World Wide Web (e.g., web pages, for example, web pages visited by a user in a web browsing session). As discussed in further detail below, documents are indexed and processed (or “harvested”), a global dictionary is created, a number of topics are derived from the global dictionary, and the documents are clustered into the derived topics (also referred to herein as themes).

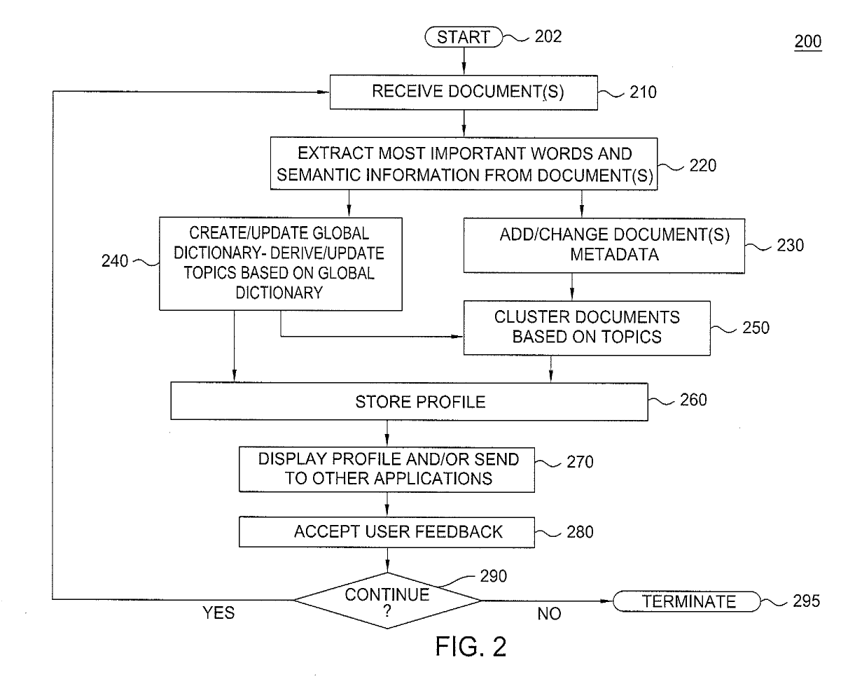

Each of the components of harvester 110 will now be described. In particular, module 112 is configured for extracting the most important words (or keywords), including semantic information, from various source documents which may be stored in and accessed from memory 119. Module 112 may also be configured to extract keywords from network documents viewed, retrieved, modified, etc. via network interface 140. In one embodiment, module 112 implements a process substantially as described in connection with step 220 of the exemplary method 200 depicted in FIG. 2 and described in greater detail below.

Module 114 is a “tagger” configured to add or change document metadata based upon the keywords extracted from the source document by module 112. In one embodiment, module 114 implements a process substantially as described in connection with step 230 of the exemplary method 200 depicted in FIG. 2.

Module 116 is configured to derive topics from the keywords extracted by module 112. In one embodiment, the process described in FIG. 2 step 240 may be implemented in module 116 for creating a global dictionary and deriving topics therefrom. Module 116 may be further configured to transmit all or a portion of a created user profile to memory 119 for storage. For example, a global dictionary, derived topics and/or associated weights determined by module 116 may comprise all or part of the user profile in accordance with embodiments of the present disclosure.

Module 118 is configured to cluster documents based on the topics. For example, in one embodiment module 118 is configured to associate documents with topics based upon the document metadata created/modified by module 114 and the topics derived by module 116. In one embodiment, this process is described in connection with step 250 of method 200. Further, in one embodiment module 118 is configured to forward all or a portion of a user profile to memory 119. For example, the unique clustering of documents determined by module 118 may comprise part of a user profile in accordance with embodiments of the present disclosure.

Display 130 allows the harvester 110 to output visualizations of a user profile. For example, a user profile may be retrieved from memory 119 and provided to display 130 for viewing by a user. Display 130 may, in addition, provide a deskbar that provides interactive options for the user to interact with the harvester 110. For instance, input device 150 allows a user to provide various inputs to the harvester 110, e.g., in response to the interactive deskbar displayed by display 130. In one embodiment, the user can specify configurable parameters with respect to the maximum number of words and/or topics stored in connection with the user profile maintained by the harvester 110. The user can also provide feedback as to the accuracy of the user profile maintained by the harvester 110 via input device 150. In addition, network interface 140 provides a means for the harvester 110 to transmit the user profile to other applications or other entities, and also allows the harvester to access network documents (e.g., webpages) in performing a web-crawling function. Aspects of such functionality are described in greater detail below in connection with step 270 of the exemplary method 200.

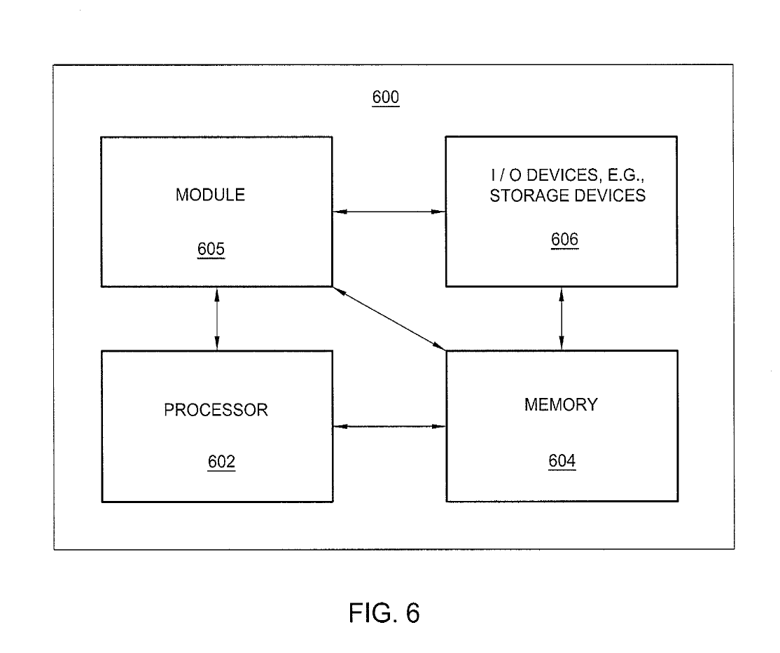

FIG. 2 is a flow diagram illustrating one embodiment of a method 200 for building a user profile (e.g., a profile that describes the interests of the user), according to the present disclosure. The method 200 may be implemented, for example, by the harvester 110 illustrated in FIG. 1. As such, reference may be made in the discussion of the method 200 to various components of the harvester 110, as well as other components of the harvester system 100. However, the method 200 is not limited to implementation by a harvester configured in accordance with FIG. 1 and may, in fact, be implemented by a harvester having alternative configurations and components. For example, the method may be performed by the general purpose computer illustrated in FIG. 6, specifically programmed to perform steps of the method 200 (e. g., instructions stored in memory and executed by a processor).

The method 200 is initialized at step 202 and proceeds to step 210, where the method receives a source document, or source documents (e.g., via monitoring of the user's interactions with a computing device). For example, in one embodiment an initial user profile may be created from an initial or “seed” set of documents. The documents may be specified by the user and provided to the method 200. Alternatively, or in addition, the method may use a default set of documents to build an initial user profile. For instance, the method may use sent and received emails within the last 30 days in order to build an initial user profile.

In one embodiment, at step 210 the method 200 retrieves the last N accessed documents. In one embodiment, the last N accessed documents are the last N documents accessed by the user from local storage (e.g., from a user device such as a personal computer, mobile wireless device, and the like).

In another embodiment, the last N accessed documents are the last N documents accessed by the user from shared or remote storage (e.g., a World Wide Web server, or a company server that the user shares with others).

In one embodiment, the method actively obtains documents by harvesting such documents from various locations. For example, a user's computer may store records which identify the user's interactions with various applications, such as the most recently accessed, created, saved, modified and/or viewed files/documents (e.g., emails read and sent by the user, word processing documents used, pictures viewed, videos viewed, blog/social network postings created). In addition, a web browser on the user's computer may store records pertaining to websites recently visited by the user. Source documents reflecting user interactions with various applications may further include records, configuration files, cookies and the like, pertaining to such things as the creation, deletion, modification, or viewing of an entry in a calendar application that tracks appointments made by the user, the creation or updating of an account associated with the user in a social media application (e.g., FACEBOOK, LINKEDIN, and the like), viewing by the user of social media created or posted by another individual (e.g., another users LINKEDIN profile), and similar user tasks.

In one embodiment, the method 200 checks for modified documents on a periodic basis (e.g., every X minutes). In another embodiment, the method retrieves or receives a document in response to a trigger being detected in the user's workflow (e.g., on the user's personal computer). The trigger may be, for instance, the user opening a new document, the user closing a document, the user editing a document, the user reading an email, the user responding to an email, the user accessing a calendar application, the user accessing a Web page, and the like. In this case, an iteration of the method 200 may take into consideration the changes to or addition of only a single document. In particular, a user profile may already exist, and the performing of the steps of the method 200 may comprise a subsequent iteration of the method. As such, the method 200 may serve to incorporate a new document or changes/viewings of existing documents into the existing user profile. In other embodiments, such as for creating an initial profile, or where the method checks for modified/updated documents on a periodic basis, the method may be performed with respect to a plurality of documents simultaneously. For ease of reference, most of the following discussion of the exemplary method 200 will only describe operations and processes with respect to a single document. However, it should be understood that such steps, operations and processes may be extended to be performed with respect to several document simultaneously.

In step 220, the method 200 extracts keywords from the received document (or documents). For example, the method may use various algorithms to determine the most important words and/or the most frequent words contained in a text document. In one embodiment, graphics and shapes in a document may be analyzed and converted to text tokens for future matching and similarity measurements. Thus, such text tokens may be included in the extraction of keywords and the determination of the most important words and semantic information at step 220. In the case of an audio, video, or mixed media file, step 220 may also comprise a speech to text conversion, natural language processing and/or other data transformation, for example. Alternatively, or in addition, in the case of an audio/video file, the extraction of keywords (e.g., most important words and/or the subset of semantic information) may comprise accessing metadata pre-appended to the file by the author. Thus, a user may listen to an audio file containing a piece of music, a news report, a recorded lecture or debate, and the like. The creator, producer and/or distributor of the audio file, or the user, may have added preexisting metadata to the file such that the file is searchable and indexable by keywords in the metadata. In this case, the method may give appropriate weight (e.g., a greater weight) to keywords appearing in author or user created metadata to account for the implicit importance of such words. In particular, if an author, distributor or the user felt it was important enough to include certain keywords/tags in metadata, the method 200 may consider metadata keywords that were manually input to have greater relevance/importance.

In one embodiment, when extracting the most frequent words from an email or other document, the method 200 may ignore certain words such as prepositions, conjunctions, or stop words. These words will often appear with a high frequency in text documents, but convey little information with respect to the topics that are germane. In addition, the method 200 may employ a stemming technique wherein words may be modified to account for different parts of speech, or words sharing the same root. For example, verbs may be converted to noun form prior to being counted (e.g., “drive” and “driving” appearing in the same document will result in a count of 2 for the word “driving” as opposed to the words being counted separately).

In addition, the method may employ various techniques for determining the most important words in a document. For example, in the case of a HTML document, words that appear in a header may be given a greater weight than words that appear elsewhere. In the case where a user has bookmarked certain portions of a file or document, words that appear in that section may be given a greater weight. In addition, words that appear in a larger font may be given a greater weight than words that appear in a smaller font. It should be understood that various other, further and different techniques may be used to determine the most important words and/or the relative importance of words in a document. Thus, the foregoing is provided by way of example only, and the present disclosure is not so limited.

In one embodiment, the most important words in a document are extracted and ranked/weighted using a modified term frequency-inverse document frequency (tf-idf) algorithm relying upon a global dictionary, user activity, recency information, and learning as described in further detail below.

Following step 220, the method proceeds to steps 230 and 240. In step 230, the method adds or changes document metadata. For example, if in step 220 the method determines that the most important or most frequent words pertaining to a document are word X and word Y, the method may append such information to the document in the form of metadata. In addition, any text tokens corresponding to graphics, shapes, audio, and the like may be included in the document metadata for future use. In one embodiment, the document may already contain metadata, or have metadata appended thereto, in which case the new information may be added to previously existing metadata. In the case where step 210 involves receiving an update to a document, the method may determine in step 220 that the top keywords in the document have changed. For instance, the user may have deleted several paragraphs in a paper and added several more pages, resulting in the change. In this case, at step 230, the method may modify/update existing metadata appended to the document (e.g., the most important or most frequent words in the document).

In one embodiment, the method 200 stores a number of keywords. The number of stored keyword entries may vary in proportion to the size of the file. For example, in one embodiment, a 500 kilobyte document may store the 10 most important keywords whereas a 1 megabyte document may store 20 keywords in metadata attached to or integrated with the document. Alternatively, the method 200 may simply store a fixed number of word entries that is the same for each type of document, regardless of its size. In one embodiment, the number of stored words in each document is a user configurable parameter that the user can specify (e.g., using an input device). In addition, the method 200 may also track the number of times or how frequently a document is accessed, and may store such information in the document metadata.

In one embodiment, at step 230, the method creates or updates a “smart summary” for a document. For example, a smart summary is created by extracting the sentences (or sections of sentences) which are deemed most important because the sum of the weights of all their most important words is the highest. In one embodiment, the smart summary comprises pointers to the identified sentences or sections. The pointers may be stored in the document metadata along with the keywords, semantic information and other electronic information. In another embodiment, the relevant sentences or sections are copied and stored directly in the document metadata. A smart summary of the document may thus be accessed and displayed to the user on the fly or at a later time (e.g., in response to a user search query).

In step 240, the method 200 creates/updates a global dictionary and derives topics (or updates topics) in accordance with the keywords determined in step 220. For example, the method 200 may aggregate the keywords derived from numerous source documents and store such information in a global dictionary. In one embodiment, keywords are aggregated from the documents comprising an initial set of documents received in step 210 in order to create the global dictionary. In another embodiment, the keywords are aggregated from the N last accessed documents. In still another embodiment, the keywords are aggregated from all or a subset of documents accessed, created, modified, viewed or otherwise used in a particular time period (e.g., all documents used in the last two days).

As mentioned above, keywords (including semantic information) may be stored as metadata appended to and/or integrated with each source document. However, in one embodiment, the keywords stored in a relational database instead of, or in addition to being stored as metadata. The keywords may comprise, for example, the most important words or the most frequent words contained in each document, as well as semantic information (e.g., place names, email addresses, phone numbers) which may also be determined to be most important words. In this regard, a “word” or “keyword may also cover such things as dates, proper nouns, addresses, phone number, email addresses, and the like. In any case, the keywords in each document may contain a weight for each word (or phone number, or email address, etc., in the case of semantic information) based on a ranking, rating, count or other means of differentiating between words (e.g., a score indicating the relative importance of each word). Thus, in one embodiment a global dictionary is created that maintains a single combined list of keywords, or the most “important” words, in all of the relevant source documents. For example, if a keyword appears frequently in a first source document and has a weight of 10, and the same word appears in a second source document with a weight of 23, the method 200 may track a combined weight for the word as 33 in the global dictionary.

In one embodiment, the score or weight for a word in the global dictionary is calculated based on a modified tf-idf algorithm, which can be further modified by learning and by the user interacting with the method (e.g., by queries issued, documents opened, updated, etc.). For example, the tf-idf process weights or scores a word appearing in a particular document taking into account the frequency of the word in that document and the inverse of the frequency of the word appearing in many other documents. Specifically, it is assumed that where a document appears with high frequency in a document, but the word appears with a similar high frequency in many or most other documents, the word may be a very common word that does not do a good job in conveying the actual subject matter of a document. The tf-idf algorithm will thus de-emphasize very common words such as “the”, “a”, “he”, “when”, etc. However, one embodiment uses a modified if-idf algorithm. In particular, several additional factors may be included in determining a weight assigned to a word beyond the weight that might be determined using a standard tf-idf algorithm. For example, a user may manually adjust a weight or score for a particular word, group of words, or even an entire topic. In addition, the weight may change according to how recently or long ago a document was accessed, how frequently the user consults or edits the document, and other factors. A similar process is followed for additional words and additional source documents.

In addition, at step 240 the method 200 may store aggregate weights for each and every word that appears in any of the source documents. However, in one embodiment, the method 200 only tracks the X most important words, or keywords. The number X may be a user configurable parameter or may be set by default by the method 200 (e.g., 50,000 words). In one embodiment, the weights for each word may be modified based upon the frequency of viewing of particular documents. For instance, if a user frequently accesses a particular document during a defined time period (e.g., one week) the weights of the words in that document may be multiplied by a modifier such that the words are given even greater weight/importance when counted in an aggregate count across many documents.

In one embodiment, the relative weights of words appearing in a particular document are reduced based on the recency of accessing/creating a document. For example, word X may have a weight of 100 in a global dictionary. The appearance of word X 20 times in document 1 may contribute 20 to the overall weight of the word in the global dictionary. However, document 1 may have been accessed four days earlier. In this case, document 1 may be becoming stale with respect to the current interests of the user. Accordingly, the method 200 may reduce the contributory factor of document 1 to the overall global dictionary weight for word X by 10% for each 24 hours that passes from the time of accessing document 1. Thus, 4 days later, the contribution of document 1 to the global dictionary score for word X may be only 10*.9*.9*.9*.9=6.561. The global dictionary, user actions, and recency information may be subsequently used by another iteration of the method 200 at step 220 in order to determine the most “important” words in a document. As such, words in a new document that are the same or related to words in other recently accessed documents will be given an even greater weight than those words related to words in other documents that are more “stale” and were accessed further in the past. It should be noted that any and all of the factors discussed herein that may affect the weight or score of a keyword may comprise the “modification” to the tf-idf algorithm described above.

Also at step 240, the method 200 further processes the aggregated keywords (e.g., as maintained in the global dictionary) and their associated weights to infer a plurality of subjects, or topics, of interest to the user. In particular, the method 200 may determine one or more topics or themes that, in part, define the user profile that is being created or modified. For example, the global dictionary may include the keywords X and Y. The method 200 may determine that these two words are related (and therefore should be grouped into a same topic). This information may be extracted, directly from the electronic information in the source documents used by the method 200 to create the user profile, or this information may be part of a previously created knowledge base. Thus, the association between words may, in one embodiment be based upon the co-association of the words in documents created and used directly by the user. This information may also inform the tf-idf algorithm used in a subsequent iteration of step 220. However, the association between words may be based upon co-location in documents that are not directly related to the user. In one embodiment, the method 200 may use a knowledge-base of word associations created using numerous public documents (such as Wikipedia®) as a basis for determining the word associations. For instance, a knowledge base may be used to augment and categorize the knowledge obtained by the method through harvesting and processing the source document(s). In particular, the method 200 may search through the knowledge base (e.g., Wikipedia articles) related to the semantic information extracted, and gather key words or related concepts from these articles. The method 200 may further fetch categories in the knowledge base articles (e.g., categories at the bottom of a typical Wikipedia page) to help augment the knowledge regarding associations between words, and to assist (in step 240) in classifying the words in the global dictionary into topics and in classifying the harvested documents into the created topics.

In one embodiment, a knowledge base may also be used to disambiguate terms, such as acronyms. For example a document might contain the acronym RFP but not the term “Request for Proposal”. If a user later search for “Proposal”, it will therefore not be found. The method 200 may therefore “augment” a source document by adding “Request for Proposal” as a metadata associating it with the acronym RFP, with some weight or probability derived from the knowledge base, which will enable the document to be found even if the user does a search for “Proposal”. In addition, the appearance of a term and its acronyrn(s) may be counted as appearances of the same keywords, as opposed to being counted (and weighted) as separate entries in the document metadata and in the global dictionary.

In any case, at step 240 the method 200 aggregates related keywords and classifies the words into topics, or themes. For example, one topic may be created containing the keywords X, Y and Z, which were determined to have a sufficient degree of relation amongst one another to warrant being grouped into a topic. In one embodiment, the topic is titled with the most frequently appearing, or most important of the keywords, based upon the electronic information of the source documents (i.e., the collective metadata). In another embodiment, the title of a topic is extracted in consultation with a knowledge base, such as by finding the concept(s) which most closely match a topic's keyword descriptors (i.e., the keywords that are members of, or are clustered into the topic). At step 240, the method 200 may further rank and store a ranking or rating of the derived topics based upon the collective weights of keywords included in each topic. The topics with the highest scores are deemed to be those of greatest interest to the user and reflect a degree of relevance of the topics to the actual interests of the user.

At step 250, the method 200 clusters documents, based upon the topics determined in step 240. For example, the method 200 may perform a hard clustering of source documents, where multiple documents are associated with one another based upon being assigned to the same topic. In hard clustering, a source document belongs to exactly one cluster (i.e., the source document is assigned to exactly one topic). For example, although the keywords of the source document (e.g., the metadata) may include various words that belong to different topics, one or more words that belong to a particular topic may have dominant weights. In this case, the document will be assigned to a cluster for the dominant topic, even though the document has some relation to other possible topics.

In another embodiment, the documents may be assigned to or associated with different topics by soft clustering. For instance, the documents may fractionally “belong” to several topics (e.g., 25% to topic 1, 30% to topic 2 and 45% to topic 3). In one embodiment, the method 200 may automatically restrict the maximum number of topics to which a document may belong.

In another embodiment, the maximum number of topics to which a document belongs is a user configurable parameter (e.g., the user may provide an input through an interface of a user device). Note that a document may be assigned to a different topic, or the percentages of belonging to different topics may be changed, even if the particular document has not been changed or accessed. This may occur where a new document or a number of new documents are processed by the method 200, resulting in new topics being created and/or topics of low importance being dropped. For example, if the weight, or other score, falls below a threshold a topic may be dropped from the user profile. Accordingly, any documents previously belonging to the cluster associated with that topic will be reassigned to one (or more) other topics/clusters.

Following step 250, the method 200 proceeds to step 260 where the method 200 stores a user profile. The user profile may include the global dictionary and the topics derived in step 240, the weights (e.g., composite weights) associated with the respective topics and/or the document clusters determined in step 250, and other information. In one embodiment, the profile may include all topics and associated weights determined in step 240. In another embodiment, only the top X topics based on weight may be stored in the user profile. X may be a user configurable parameter or may be a default parameter used by the method 200. In one embodiment, the user profile may further include the documents clustered into the topics, as determined in step 250. In other words, the user profile may store the associations between the source documents and the topics to which the source documents belong (and the degree to which the documents belong to each cluster, if soft clustering is used).

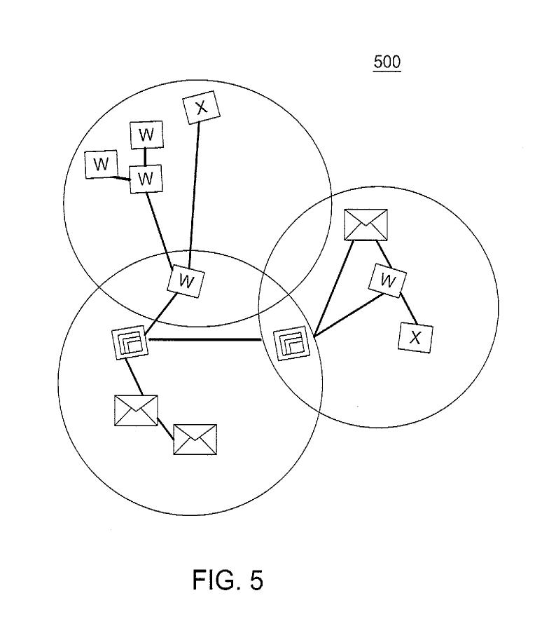

In step 270, the method 200 displays the user profile. For example, the method 200 may create a visualization of the user profile to be displayed on a user device (e.g., on a monitor or other display screen). In one embodiment, the method 200 may display a list, a chart, a graph or other arrangement showing the top topics determined in step 240 and stored in the user profile at step 260. In one embodiment, the topics may be displayed in ranked weight order. For example, topics having the highest aggregate weights are displayed first. One embodiment further provides a heat map which shows a trending analysis of the relative importance of different topics over time. For example, a topic which is losing importance (e.g., due to declining weights of its associated keywords) may be shown in a progression or sequence from red to yellow to green to blue, while a topic that is increasing in importance as compared to prior time periods may be shown in a progression from blue to yellow to orange. In addition, in one embodiment, the method 200 creates a clustering visualization which shows the different topics, and the clusters of documents which belong to those topics. An example of a clustering visualization, where soft clustering is used, is shown in FIG. 5.

Alternatively, or in addition, at step 270 the method 200 may send the created user profile to other applications. In one embodiment, the method 200 provides the user profile to third parties to provide relevant content based on the user profile. For example, the method 200 may provide the user profile to a news distribution website and, based on the profile, the news distribution site may return content of interest. For instance, the user profile includes one or more topics that are considered to be of interest to the user. The different topics may have different weights or scores (e.g., a composite score based on the sum of the individual scores/counts of the keywords associated with the topic). The news site or content provider may retrieve documents or other media content having similar topics (e.g., as determined based on a similar analysis of the content distributor's content, e.g., word scoring, metadata analysis, topic tagging, and the like).

The method 200 may provide the user profile based on a user input. For example, the user may send and instruction via an input device instructing or authorizing the sharing/providing of the user profile with one or more third parties. The user profile may thus be used to discover information of interest to the user and present such information to the user to interact with or view. For example, the user may desire to have news from a favorite news provider pushed to the user's device once per day, in the morning. In addition, the user would like only relevant content based on the user profile to be delivered, as opposed to receiving all new content from the news provider for that day. If so authorized, the method 200 may send the current user profile to the news provider and receive back the relevant content based on the user profile. In another embodiment, the user may be visiting a website of a news provider that is capable of providing relevant content based on a user profile. The website may prompt the user to share or provide a user profile, following which the website offers to return targeted content based on the user profile. The user may, via an input device, authorize the method 200 to provide the user profile in response to the prompt.

In one embodiment, the user profile may be provided to external parties in order to deliver relevant/targeted advertising. For example, if the user is visiting various websites and must receive various advertising in order to access the pages of the website, the user may wish to at least receive potentially interesting advertising. If the user profile is provided to an advertising server providing the advertising for the website, more relevant advertisements can be delivered to the user. In still another embodiment, the user may share the user profile with advertisers or network providers in exchange for a fee or a discount on services (e.g., discounted internet access service charges, online media credits, etc.).

In another embodiment, at step 270 the method 200 may proactively retrieve content of interest for various sources. For instance, the method 200 may perform a web crawling function by navigating popular content provider sites for content that matches the user profile (e.g., as determined based on a similar analysis of the available content, such as, word scoring, metadata analysis, topic tagging, and the like). In one embodiment, the user may specify a number of news websites, social media websites or other content sites for the method 200 to crawl. In another embodiment, the method 200 may automatically determine where to search for relevant content, e.g., determining a list of potential sources by geographic location first, then creating a set of relevant content to output based on matching source content from the list of sources to the user profile.

In one embodiment, the user profile may be provided to an application (which may be hosted by an external provider) to suggest relevant content based upon the interests of users with similar profiles. As such, the user profile may be compared with numerous other user profiles. The most popular content, based upon the interests of the most similar users may therefore be provided to the user. In another embodiment, the user may allow the user profile to be shared on a dating or other social interest website (e.g., FACEBOOK or LINKEDIN), in order to identify similar other users or dating prospects. It should be noted that in one embodiment, the sharing or providing of the user profile with third parties is entirely within the control of the user. If the user does not wish to share or publish the profile for others to view, the user may limit the use of the profile to the user's own device or local network. If the user chooses to share the profile publicly, the method 200 may determine one or more other individuals sharing at least one of the same interests as the user. For example, the (first) user and a second user may both have the same topic as part of their respective user profiles. In one embodiment, the method 200 may recommend additional content or information to the first user based upon additional interests of the second user. For example, if the first user and the second user share the same interest in topic X, which appears in both user profiles, but only the second user has topic Y in his or her user profile, the method 200 may recommend content related to topic Y to the first user; the inference being that since both users have one shared interest, the first user is more likely to be interested in other topics found interesting to the second user, even though the first user has not previously shown an interest in such topics.

At step 280, the method 200 accepts user feedback regarding the user profile. For example, the user may view a clustering visualization of the user profile and determine that one or more documents are incorrectly grouped into the wrong cluster(s). The user may manually adjust the membership of the document, or documents, in the one or more clusters. For example, the method 200 may accept an interactive input from a user (e.g., via an input device) for dragging and dropping a document from one cluster to another, the method causing the visualization display to reflect the change in real-time. Simultaneously, the method 200 may update the user profile (e.g., in document metadata, the global dictionary, topic keywords, weight, membership of documents in clusters) to reflect the changes. In another example, the user may view the visualization displayed at step 270 and decide that he or she is not interested in various topics determined by the method 200. For instance, the user may have recently prepared an income tax return, calendared the tax return due date, accessed bank account records, pay records, instructions on preparing tax returns and schedules from the Internal Revenue Service website, used tax preparation software, emailed an accountant, and accessed other source documents associated with a topic of “taxes”. However, the user actually dislikes the topic of taxes and only prepares a tax return as required by law. Once the user is finished preparing the tax return, he or she has no further interest in taxes until the next year. Accordingly, when the user desires that the method 200 use the user profile to obtain relevant content from content providers, the user does not want the topic of “taxes” included in the user profile, because this may result in the method 200 retrieving documents related to taxes (e.g., news articles related to tax code changes or similar matters). Thus, at step 280, the method 200 may accept a user input removing or deprioritizing a particular topic in the user profile. In one embodiment, the entire topic is simply removed from the user profile. Any document that is the particular topic cluster may be reassigned to a different topic/cluster (or to multiple different topics/clusters in the case of soft clustering). In addition, metadata appended to tax-related documents may be caused to reflect a reduction modifier that minimizes the relative importance of keywords in the tax-related documents relative to other documents contributing to word scores in the global dictionary.

In order to prevent the method 200 from recreating the un-desired topic in a subsequent iteration of the method 200, the method 200 may maintain the topic in a blacklist or other named data structure containing a list of topics that cannot be included in the user profile. In addition, the blacklist may include various words associated with the undesired topic. In subsequent iterations of the method 200, the method 200 may ignore any scores/counts associated with such words or automatically reduce the weights given to such words. In one embodiment, the specific words included in the blacklist are automatically included based upon the association of the words with the particular topic identified by the user for removal. In another embodiment, the user may also specify specific words for the method 200 to ignore or deemphasize, in addition to a broader topics to be deleted.

In addition, at step 280, the method 200 may accept a user input to associate various words to different topics. For example, the method 200 may associate the word “art” with topics or words such as “painting”, “sculpture” and “poetry”. However, the user may actually be a patent agent that searches for relevant “art” with respect to patents and patent applications. In this case, the user may specify to the method 200 that the term “art” should be associated with the topic/concept of “patents” as opposed to “works of art.”

At step 280, the method 200 may also accept an input from the user to create or change the titles for the topics so that they have names that are more meaningful to the user. For example, the method 200 may group the most important words or most frequent words into different topics based upon word associations (as described in connection with steps 240 and 250). However, a topic may be untitled, or may be simply given a title based upon the most frequent or most important word for that topic. The user may have a descriptor for the topic that is more relevant or that is personally meaningful, and that he or she would like to use. Thus, through a user input, the user may specify to the method 200 a new or different title for the particular topic that should be used. The visualization of step 270 may be updated accordingly to display the new topic title in the displayed list and/or clustering visualization.

In one embodiment, the user feedback at step 280 may not be explicit. Rather, the method 200 may infer user feedback based upon an action taken by the user in response to a recommendation that is made based on a consultation with the user profile. For example, the method 200 may recommend certain content retrieved from the web in performing a web-crawling function using the user profile. If the user ignores certain recommended content but views other content, the method 200 may incorporate the further user interactions with these documents into the user profile (e.g., by re-performing steps 210-280 with respect to the viewing/ignoring of recommended content). In one embodiment, the method 200 may track how long a user spends interacting with a recommended piece of content. For example, a user may open and scan all of the recommended content and may quickly determine that certain ones are of no interest based upon a quick read of a summary, title or headline. Other documents, such as a news article of interest, the user may spend more time viewing. In harvesting the user interactions with the recommended content, the method 200 may provide a greater weight to keywords harvested from content that the user spends a greater amount of time viewing. The relative weighting based on the above may be reflected in the document metadata and/or in word weights/scores in the global dictionary.

In another embodiment, the method 200 may track implicit user feedback based upon user interactions pertaining to a query for documents (e.g., a desktop query or a web query), such as a natural language query or terms and connectors query. A number of documents may be returned by the method 200 responsive to the query. In one embodiment, the method 200 may consult documents' metadata (i.e., keywords and weights defining the most important words, semantic information, etc.) and match the keywords to the query terms. The method 200 may further monitor the user's behavior following the method providing the search results. The user behavior may then be used to modify various aspects of the user profile. For example, the method 200 may observe that a user does not open any documents after receiving the set of search results, modifies the query, is provided a second search results, and opens many documents in the second set of search results. In response, the method 200 may modify the clustering of documents, the weight of words in the documents, or take other actions to update the user profile. For instance, if many of the documents in the first search result are in one cluster, and such documents are contained in the second search results with documents that are not in the cluster, the method may determine that these documents have a greater degree of relation than previously determined. Accordingly, document weights, word weights and other aspects of the user profile may be adjusted to cause the documents in the second set of search results into a common cluster.

At step 290, the method 200 determines whether to continue or to terminate. In one embodiment, the method 200 may continuously execute and continuously update the user profile via the steps 210-280. In this case, the method 200 returns to step 210. In another embodiment, the method 200 is performed on a schedule (e.g., once per hour, once per day, etc.). For example, the method 200 may persistently store a user profile. At scheduled times, the method 200 may self-execute, performing steps 210-280. In this case, the method 200 simply proceeds to step 295. If the method 200 has been invoked for a single iteration, the method 200 also proceeds to step 295.

At step 295, the method 200 terminates. The method 200 will only iterate again at the next scheduled time, or when otherwise invoked (e.g., specifically by the user or by another authorized application).

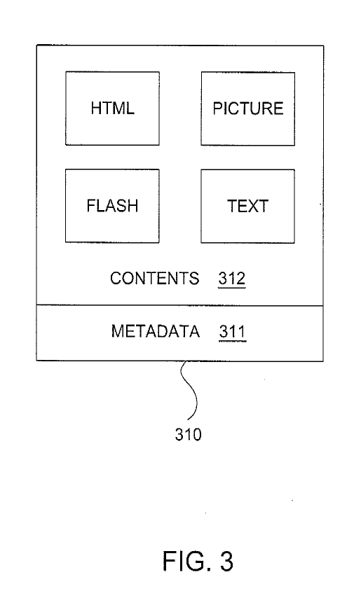

FIG. 3 depicts a representation of a source document 310 according to various embodiments of the present disclosure. Source document 310 may comprise a text/word processing document, a spreadsheet, a slideshow presentation, an animation (e.g., an ADOBE FLASH object), an audio file, a portable document format document, a video file (e.g., a MPEG, Quicktime video, and the like), a picture (e.g., a bitmap, graphics interchange format (GIF), JPEG, and the like), a webpage or other multimedia file or object. Thus, the contents 312 of the exemplary source document 310 may include mixed media (e.g., various portions of the document/file may comprise content in different formats). In the content 312 depicted in FIG. 3 include hypertext markup language (HTML), text, FLASH and pictures. Thus, document 310 may comprise a webpage incorporating all of these content types. Document 310 also includes a metadata portion/metadata field 311. In one embodiment, the metadata field 311 is appended to the document 310 by the process described in connection with the exemplary method 200 depicted in FIG. 2, in particular, at step 230.

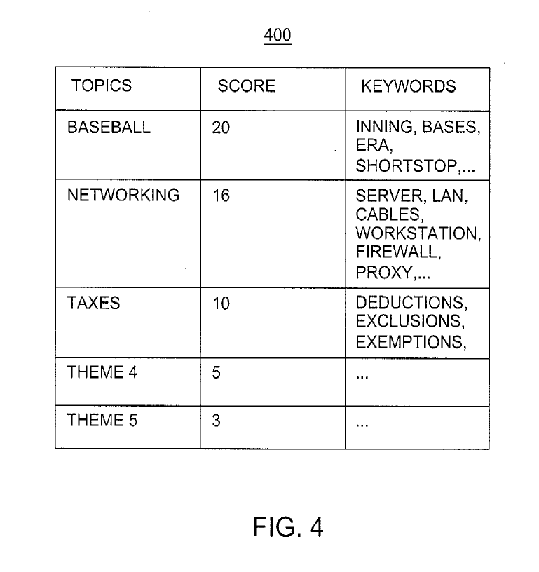

FIG. 4 depicts one representation of a visualization of a user profile according to embodiments of the present disclosure. In the embodiment shown in FIG. 4, the visualization comprises a table 400. The table 400, which may comprise only a portion of the user profile, includes a list of topics, each row corresponding to one topic. Each row includes a topic title, or theme, a topic score (which ranks each of the topics versus other topics by weight), and keywords associated with the topic. Although FIG. 4 depicts a two dimensional table 400 representing the user profile, it should be understood that other, further and different embodiments may incorporate other data structures to represent the user profile. For instance, while FIG. 4 depicts an embodiment where topics are arranged by weight, or score, in other embodiments a different representation may be used, such as an alphabetic arrangement. In yet another embodiment, the top documents for each topic may be displayed (e.g., instead of or in addition to the top keywords in the last column). In one embodiment, a visualization of the user profile may comprise the display of the table 400 as shown in FIG. 4. For example, the table 400 may be provided to a display device (e.g., attached to a user's computer, mobile device or other hardware) for display to a user. In one embodiment, the visualization may comprise only the top X topics, in rank order. X may be a user defined parameter or may be a default number set by a user profile generating system (such as the system depicted in FIG. 1).

FIG. 5 depicts one embodiment of a clustering visualization of a user profile in accordance with embodiments of the present disclosure. For example, FIG. 5 represents one embodiment of the output of a display showing a clustering visualization of a user profile. In one embodiment, the user profile is created and updated according to the exemplary method 200 shown in FIG. 2. In particular, the visualization created in step 270 may be sent to a display device (e.g., attached to a user's computer, mobile device or other hardware) for display to a user. The embodiment of FIG. 5 shows a soft clustering of documents into topics (where a document may belong partially to several different topics). In one embodiment, the display of the clustering visualization is interactive and allows the user to delete documents from the clusters, drag documents from one cluster to another, etc. For example, the clustering visualization may appear on a display device such as display 130 in FIG. 1 and the user may interact with and manipulate the display via commands entered through input device 150 (e.g., a keyboard, mouse, touchpad, etc.).

FIG. 6 is a high level block diagram of a general purpose computing device 600 that can be used to implement embodiments of the present disclosure for building a profile that describes interests of a user, as described above. It should be understood that embodiments of the disclosure can be implemented as a physical device or subsystem that is coupled to a processor through a communication channel. Therefore, in one embodiment, a general purpose computing device 600 comprises a processor 602, a memory 604, a user modelization module 605, and various input/output (I/O) devices 606 such as a display, a keyboard, a mouse, a modem, and the like. In one embodiment, at least one I/O device is a storage device (e.g., a disk drive, an optical disk drive, a floppy disk drive).

Alternatively, embodiments of the present disclosure (e.g., user modelization module 605) can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the user modelization module 605 for building a profile that describes interests of a user described herein with reference to the preceding Figures can be stored on a computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present disclosure have been shown and described in detail herein, those skilled in the art can readily devise many other varied embodiments that still incorporate these teachings.

What is claimed is:

1. A computer-based method for building a profile that describes interests of a user, the method comprising:
monitoring automatically over time a plurality of interactions between the user and a computing device controlled by the user, wherein the plurality of interactions includes interactions with a plurality of different computer applications;
extracting automatically electronic data from the plurality of interactions;
determining automatically the interests in accordance with the electronic data; and
saving the interests in the profile, such that the profile is based on behaviors specific to the user.

2. The computer-based method of claim 1, wherein the plurality of interactions includes an email sent or received by the user.

3. The computer-based method of claim 1, wherein the plurality of interactions includes an access of a document.

4. The computer-based method of claim 1, wherein the plurality of interactions includes a web browsing session.

5. The computer-based method of claim 1, wherein the plurality of interactions includes a search executed by the user.

6. The computer-based method of claim 1, wherein the plurality of interactions includes a creation of an entry in a calendar application that tracks appointments made by the user.

7. The computer-based method of claim 1, where the plurality of interactions includes a creation of a bookmark in a web browser application used by the user.

8. The computer-based method of claim 1, wherein the plurality of interactions includes a creation or update of an account associated with the user in a social media application.

9. The computer-based method of claim 1, wherein the plurality of interactions includes a viewing by the user of social media associated with another individual.

10. The computer-based method of claim 1, wherein the electronic data comprises:
keywords mined from the plurality of interactions.

11. The computer-based method of claim 10, wherein the keywords are mined by processing the plurality of interactions in accordance with natural language processing.

12. The computer-based method of claim 10, wherein the determining comprises:
inferring a plurality of subjects from the keywords; and
identifying which of the plurality of subjects are of greatest interest to the user.

13. The computer-based method of claim 1, wherein the electronic data comprises:
a keyword that occurs in the plurality of interactions with a high frequency relative to other terms occurring in the plurality of interactions.

14. The computer-based method of claim 13, wherein a weight is assigned to the keyword, the weight being based on a frequency with which a document containing the keyword is accessed by the user.

15. The computer-based method of claim 14, wherein the weight is modified based upon user feedback.

16. The computer-based method of claim 14, wherein the weight is modified based upon observations of user behavior.

17. The computer-based method of claim 1, wherein the electronic data comprises:
a graphic occurring in the plurality of interactions.

18. The computer-based method of claim 17, wherein the graphic is converted into one or more text tokens.

19. The computer-based method of claim 1, further comprising:
tagging the electronic data.

20. The computer-based method of claim 1, further comprising:
clustering the electronic data.

21. The computer-based method of claim 1, further comprising:
classifying the electronic data.

22. The computer-based method of claim 1, further comprising:
receiving feedback from the user regarding the profile; and
updating the profile in accordance with the feedback.

23. The computer-based method of claim 22, wherein the feedback comprises an action taken by the user in response to a recommendation that is made based on a consultation with the profile.

24. The computer-based method of claim 1, further comprising:
continuously updating the profile in accordance with new interactions between the user and the computing device.

25. The computer-based method of claim 1, wherein the interests comprise long-term interests indicated by the plurality of interactions collectively.

26. The computer-based method of claim 1, further comprising:
using the profile to assist the user in completing a workflow on the computing device.

27. The computer-based method of claim 26, wherein the workflow is a collaborative workflow including the user and at least one other individual.

28. The computer-based method of claim 1, further comprising:
using the profile to discover information of interest to the user; and
presenting the information to the user.

29. The computer-based method of claim 28, wherein the information resides on the computing device.

30. The computer-based method of claim 28, wherein the information resides on a network to which the computing device is connected.

31. The computer-based method of claim 28, further comprising:
assigning ratings to the information, the ratings reflecting a degree of relevance of the information to the interests.

32. The computer-based method of claim 28, wherein the information relates to a commercial product or service.

33. The computer-based method of claim 28, wherein the information relates to an employment opportunity.

34. The computer-based method of claim 28, wherein the information relates to a social opportunity.

35. The computer-based method of claim 28, wherein the using comprises:
identifying an individual with whom the user shares at least one of the interests;
identifying additional interests of the individual, in addition to the at least one shared interest,
wherein the information relates to at least one of the additional interests.

36. A computer readable storage device containing an executable program for building a profile that describes interests of a user, where the program performs steps of:
monitoring automatically over time a plurality of interactions between the user and a computing device controlled by the user, wherein the plurality of interactions includes interactions with a plurality of different computer applications;
extracting automatically electronic data from the plurality of interactions;
determining automatically the interests in accordance with the electronic data; and
saving the interests in the profile, such that the profile is based on behaviors specific to the user.

37. Apparatus for building a profile that describes interests of a user, the apparatus comprising:
means for monitoring automatically over time a plurality of interactions between the user and a computing device controlled by the user, wherein the plurality of interactions includes interactions with a plurality of different computer applications;
means for extracting automatically electronic data from the plurality of interactions;
means for determining automatically the interests in accordance with the electronic data; and
means for saving the interests in the profile, such that the profile is based on behaviors specific to the user.
